(19) United States
(12) Patent Application Publication
(10) Pub. No.: US 2025/0384547 A1
(43) Pub. Date: Dec. 18, 2025

(54) TABLET QUALITY INSPECTION SYSTEM AND METHOD BASED ON MODULAR MACHINE VISION RECOGNITION

(71) Applicants: Jiangxi University of Chinese Medicine, Nanchang (CN); JIANGZHONG PHARMACEUTICAL CO., LTD., Nanchang (CN)

(72) Inventors: Zhenfeng WU, Nanchang (CN); Ziqian WANG, Nanchang (CN); Xiaorong LUO, Nanchang (CN); Xuecheng WANG, Nanchang (CN); Zhijian ZHONG, Nanchang (CN); Ming YANG, Nanchang (CN)

(21) Appl. No.: 19/316,309

(22) Filed: Sep. 2, 2025

(30) Foreign Application Priority Data
Dec. 26, 2024 (CN) 202411931930.9

(51) Int. Cl. G06T 7/00; G06T 7/60; G06V 10/26; G06V 10/54; G06V 10/74; G06V 10/764; G06V 10/77; G06V 20/70

(52) U.S. Cl. CPC G06T 7/001; G06T 7/60; G06V 10/273; G06V 10/54; G06V 10/761; G06V 10/764; G06V 10/7715; G06V 20/70; G06T 2207/30108; G06V 2201/06

(57) ABSTRACT

Disclosed in the present disclosure are a tablet quality inspection system and method based on modular machine vision recognition, belonging to the field of machine vision. The present disclosure analyzes defect category according to extracted defect feature, obtains the defect category of corresponding tablet, analyzes the tablet production quality according to the tablet defect category and the corresponding defect position data, so as to accurately analyze tablet image, extract the implicit feature reflecting tablet defect, accurately analyze the defect category according to the implicit feature of the defect, and then accurately analyze tablet quality according to the classified defect category and positions, thereby improving the accuracy and the efficiency of a tablet quality inspection.

### CROSS-REFERENCE TO RELATED APPLICATION

The present disclosure claims priority to Chinese Patent Application No. 202411931930.9 filed on Dec. 26, 2024, which is hereby incorporated by reference in its entirety.

### TECHNICAL FIELD

The present disclosure belongs to the field of scene recognition, particularly to the field of pharmaceutical quality control, and more particularly relates to a tablet quality inspection system and method based on modular machine vision recognition.

### BACKGROUND

The production quality of tablet pharmaceuticals is related to the safety and effectiveness of tablets. The quality control in the tablet production is crucial. To ensure the quality of the tablet production, it is necessary to comprehensively consider various aspects such as raw materials, excipients, production processes, and devices, and take strict quality inspection and control measures. After the tablet production, it is necessary to carry out quality inspection on the formation status of the tablets. In this case, a tablet quality inspection system is needed.

In the prior art, when the quality inspection is carried out on the formation status of the tablets, it is usually to make a simple image comparison, perform a pixel analysis to find out defects and their sizes, and then carry out quality scoring according to the sizes and difference of the defects. This ignores the difference in the impacts of the defect categories on the quality, and it is impossible to accurately analyze the defect categories according to the implicit characteristics of the defects, and then fails to perform accurate analysis the tablet quality according to the classified categories and the positions of the defects. Most of the prior arts have the above problems.

To solve the problems raised in the background section, the present disclosure designs a tablet quality inspection system and method based on modular machine vision recognition.

### SUMMARY

Aiming at the disadvantages of the prior art, the present disclosure proposes a tablet quality inspection system and method based on modular machine vision recognition. The present disclosure accurately analyzes a tablet image, extracts an implicit feature reflecting a defect of the tablet, accurately analyzes defect category according to the implicit feature of the defect, and then accurately analyzes tablet quality according to the classified category and positions of the defect, thereby improving the accuracy and the inspection efficiency of a tablet quality inspection.

In order to achieve the above objectives, the present disclosure provides the following technical solutions.

In a first aspect, the present disclosure provides a tablet quality inspection method based on modular machine vision recognition, including:
S1: obtaining surface image data of a produced tablet, and obtaining surface defect data and defect position data of the tablet from the surface image data of the tablet;
S2: importing the surface defect data of the tablet into a defect feature extraction strategy to obtain an extracted defect feature;
S3: analyzing a defect category according to the extracted defect feature to obtain a tablet defect category; and
S4: analyzing a tablet production quality according to the tablet defect category and the corresponding defect position data, and removing an unqualified tablet.

As a preferred technical solution of the tablet quality inspection method based on modular machine vision recognition, the obtaining the surface image data of the produced tablet, and obtaining the surface defect data and the defect position data of the tablet from the surface image data of the tablet includes:
S11: spreading the produced tablet on a collecting end of a visual machine, and removing the background from collected images to obtain the surface image data of the produced tablet;
and the removing the background from collected images to obtain the surface image data of the produced tablet includes: obtaining collected images from the visual machine, and at the same time, obtaining a pixel value of a normal tablet and an average pixel value of the background, obtaining the pixel values of the respective pixels on a surface of each collected image, setting an image with a pixel value difference relative to the normal tablet falling within a set safe pixel value range as a tablet surface image, setting other images as background images, and obtaining contours of all the tablet surface images and the pixel value of each pixel;
S12: comparing a contour of the tablet surface image with that of the normal tablet to obtain a contour abnormal range, i.e., an image range in which the contour of the tablet surface image is different from that of the normal tablet, and comparing the pixel value of each pixel of the tablet surface image with that of the normal tablet to obtain a pixel abnormal range, i.e., an image range in which the pixel values of the tablet surface image are different from that of the normal tablet; and
S13: setting the obtained contour abnormal range and pixel abnormal range of the tablet as the surface defect, and at the same time, obtaining closest distance data of the surface defect relative to a center position of the tablet, where the center position of the tablet is center of a circumscribed circle of the tablet.

As a preferred technical solution of the tablet quality inspection method based on modular machine vision recognition, the importing the surface defect data of the tablet into the defect feature extraction strategy to obtain an extracted defect feature specifically includes:
S21: obtaining a pixel value of each pixel corresponding to a surface defect and a height of each pixel corresponding to the defect relative to a tablet plane.
S22: importing the obtained pixel value of each pixel corresponding to the surface defect into a defect pixel feature extraction model to extract a defect pixel feature;
and the defect pixel feature extraction model specifically includes:
S221: obtaining the pixel value of each pixel corresponding to the surface defect, and setting a defect pixel with a maximum pixel value deviation relative to a pixel corresponding to a normal tablet as a defect center pixel;
S222: setting the pixel value difference as a gradient around the defect center pixel, and dividing the defect into a plurality of pixel regions; and
S223: obtaining an image contour of each pixel region of the defect, an average distance of the pixels in the pixel region relative to the defect center pixel, and an average pixel value per pixel regions;
S23: importing the height of each pixel corresponding to the defect relative to the tablet plane, and importing the heights into a defect deformation feature extraction model to extract a defect deformation feature;
and the defect deformation feature extraction model specifically includes:
S231: obtaining an absolute value of a height of each pixel corresponding to the defect relative to the tablet plane, and setting a pixel with a maximum absolute value of the height, among the pixels corresponding to the defect relative to the tablet plane, as a deformation defect center pixel;
S232: setting a height difference as a gradient around the deformation defect center pixel, and dividing the defect into a plurality of deformation regions; and
S233: obtaining a contour of each deformation region and an average value of the absolute values of the heights of respective pixels in the deformation region relative to the tablet plane, and at the same time, obtaining a distance between the contour of each deformation region and the deformation defect center pixel;
S24: obtaining the extracted defect pixel feature and the defect deformation feature.

As a preferred technical solution of the tablet quality inspection method based on modular machine vision recognition, the analyzing the defect category according to the extracted defect feature to obtain the tablet defect category specifically includes:
S31: obtaining an image contour of each pixel region of the defect, an average distance of the pixels in the pixel region from the defect center pixel and an average pixel value per pixel regions, and at the same time, obtaining the image contour of each pixel region of a historically classified defect, all of which are imported into a defect pixel category judgment value calculation formula to calculate a defect pixel category judgment value, and the defect pixel category judgment value calculation formula is

$$Px = {\sum }_{i = 1}^{m} \frac{xi \times Lz \times S ( si ⋂ siw )}{( xi + \vert xi - xis \vert ) \times Li \times S ( si ⋃ siw )} ,$$

where m is the number of defect pixel regions, xi is an average pixel value corresponding to an i-th pixel region of the defect, Lz is a diameter of the tablet, Li is an average distance of the pixels in the i-th pixel region relative to the defect center pixel, S () denotes an region of the image the bracket, si is a contour image corresponding to the i-th pixel region of the defect, siw is an image contour of the historically classified defect corresponding to the i-th pixel region, xis is an average pixel value of the historically classified defect corresponding to the i-th pixel region, [symbol] is an intersection of contours, and [symbol] is a union of contours;
S32: obtaining a contour of each deformation region of the defect, an average value of the absolute values of the heights of the respective pixels in the deformation region relative to the tablet plane, and an average distance between the contour of each deformation region and the deformation defect center pixel, and at the same time, obtaining the contour of each deformation region of the historically classified defect and an average value of the absolute values of the heights of the respective pixels in the deformation region of the historically classified defect relative to the tablet plane, all of which are imported into a defect deformation category judgment value calculation formula to calculate a defect deformation category judgment value, and the defect deformation category judgment value calculation formula is

$$Pb = {\sum }_{j = 1}^{n} \frac{cj \times Lz \times S ( zj ⋂ zjw )}{( cj + \vert cj - cjs \vert ) \times Dj \times S ( zj ⋃ zjw )} ,$$

where n is the number of deformation regions of the defect, cj is an average value of the absolute values of the heights of the respective pixels in an j-th deformation region relative to the tablet plane, cjs is an average value of the absolute values of the heights of the respective pixels in the historically classified defect corresponding to the j-th deformation region relative to the tablet plane, Dj is an average distance between a contour of the j-th deformation region and the deformation defect center pixel, zj is the contour of the j-th deformation region of the defect, and zjw is the contour of the historically classified defect corresponding to the j-th deformation region.
S33: obtaining defect pixel category judgment values and defect deformation category judgment values of the defect and the historically classified defect, all of which are imported into a defect similarity value calculation formula to calculate a defect similarity value, and the defect similarity value calculation formula is Mk=aPx+(1−a)Pb, where a is a pixel similarity ratio; and
S34: obtaining the defect similarity values of all the historically classified defects relative to the defect to be recognized, and setting the category of the historically classified defect corresponding to the maximum defect similarity value as the category of the defect to be recognized.

As a preferred technical solution of the tablet quality inspection method based on modular machine vision recognition, the analyzing the tablet production quality according to the tablet defect category and the corresponding defect position data specifically includes:
S41: obtaining a quality base value corresponding to the recognized defect, and at the same time, obtaining the pixel values of the respective pixels of the defect and the absolute values of the heights of the respective pixels of the defect relative to the tablet plane, and importing the obtained pixel values of the respective pixels of the defect and the absolute values of the heights relative to the tablet plane into a defect abnormal value calculation formula to calculate a defect abnormal value, and the defect abnormal value calculation formula is

$$Qx = {\sum }_{c = 1}^{Y} \frac{\vert pc - pcm \vert}{pcm} exp ( \frac{Jc}{Jm} ) ,$$

where Y is the number of pixels of the defect, pc is a pixel value of a c-th pixel of the defect, pcm is a pixel value of the tablet, exp () represents a natural constant e raised to a specified power, Jc is an absolute value of a height of the c-th pixel of the defect relative to the tablet plane, and Jm is a thickness of the tablet;
S42: obtaining the defect abnormal value, the quality base value and the closest distance data relative to a center position of the tablet of each defect on the tablet, all of which are imported into a tablet quality calculation formula to calculate a tablet quality, and the tablet quality calculation formula is

$$F = 1 - \frac{{\sum }_{r = 1}^{R} Q x r \times Tr \times ln ( 1 + \frac{Hm}{Hr + Hm} )}{Qm} ,$$

where R is the number of defects on the tablet, Qxr is a defect abnormal value of an r-th defect, Tr is a quality base value of the r-th defect, ln () represents a logarithm with base the natural constant e, Hm is an average diameter of the tablet, Hr is closest distance data of the r-th defect relative to the center position of the tablet, and Qm is a set defect abnormality threshold; and
S43: comparing the obtained tablet quality with a set tablet quality threshold, when the tablet quality is greater than or equal to the set tablet quality threshold, determining the tablet quality to be qualified, and when the tablet quality is less than the set tablet quality threshold, determining the tablet quality to be unqualified.

In a second aspect, the present disclosure provides a tablet quality inspection system based on modular machine vision recognition, which is implemented on the basis of the aforementioned tablet quality inspection method based on modular machine vision recognition, including a data obtaining module, a defect feature extraction module, a defect category analysis module and a quality analysis module;
and the data obtaining module is configured to obtain surface image data of a produced tables, and obtain surface defect data and defect position data of the tablet from the surface image data of the tablet;
the defect feature extraction module is configured to import the surface defect data of the tablet into a defect feature extraction strategy to obtain an extracted defect feature;
the defect category analysis module is configured to analyze defect category according to the extracted defect feature to obtain a tablet defect category; and
the quality analysis module is configured to analyze a tablet production quality according to the tablet defect category and the corresponding defect position data, and remove an unqualified tablet.

In a third aspect, the present disclosure provides an electronic device, including: a processor and a memory, and the memory stores a computer program that is capable of being called by the processor;
and the processor implements the aforementioned tablet quality inspection method based on modular machine vision recognition by calling the computer program stored in the memory.

In a fourth aspect, the present disclosure provides a computer-readable storage medium, which stores instructions, and when run on a computer, the instructions enable the computer to implement the aforementioned tablet quality inspection method based on modular machine vision recognition.

Compared with the prior art, the present disclosure has the following advantageous effects.

The present disclosure obtains the surface image data of the produced tablet, obtains the surface defect data and the defect position data of the tablet from the surface image data of the tablet, imports the surface defect data of the tablet into the defect feature extraction strategy to obtain an extracted defect feature, analyzes the defect category according to the extracted defect feature to obtain a tablet defect category, and analyzes a tablet production quality according to the tablet defect category and the corresponding defect position data, so as to accurately analyze tablet image, extract an implicit feature reflecting tablet defect, accurately analyze the defect category according to the implicit feature of the defect, and then accurately analyze tablet quality according to the classified defect category and position, thereby improving the accuracy and the efficiency of a tablet quality inspection.

### BRIEF DESCRIPTION OF THE DRAWINGS

Other features, objectives and advantages of the present disclosure will become more apparent by viewing the detailed description of the non-limiting embodiments made with reference to the following drawings.

FIG. 1 illustrates an overall flow diagram of a tablet quality inspection method based on modular machine vision recognition according to the present disclosure;

FIG. 2 illustrates a schematic diagram of step S2 of a tablet quality inspection method based on modular machine vision recognition according to the present disclosure;

FIG. 3 illustrates a schematic diagram of steps in a defect pixel feature extraction model in a tablet quality inspection method based on modular machine vision recognition according to the present disclosure;

FIG. 4 illustrates a schematic diagram of steps in a defect deformation feature extraction model in a tablet quality inspection method based on modular machine vision recognition according to the present disclosure; and

FIG. 5 illustrates a schematic diagram of an overall framework of a tablet quality inspection system based on modular machine vision recognition according to the present disclosure.

### DETAILED DESCRIPTION OF THE PREFERRED EMBODIMENTS

The technical solutions in the embodiments of the present disclosure will be clearly and completely described below with reference to the drawings for the embodiments of the present disclosure. Obviously, those described are only parts, rather than all, of the embodiments of the present disclosure. The following description of at least one exemplary embodiment is merely illustrative in nature, and is in no way intended to limit the present disclosure and the applications or uses thereof.

### Embodiment 1

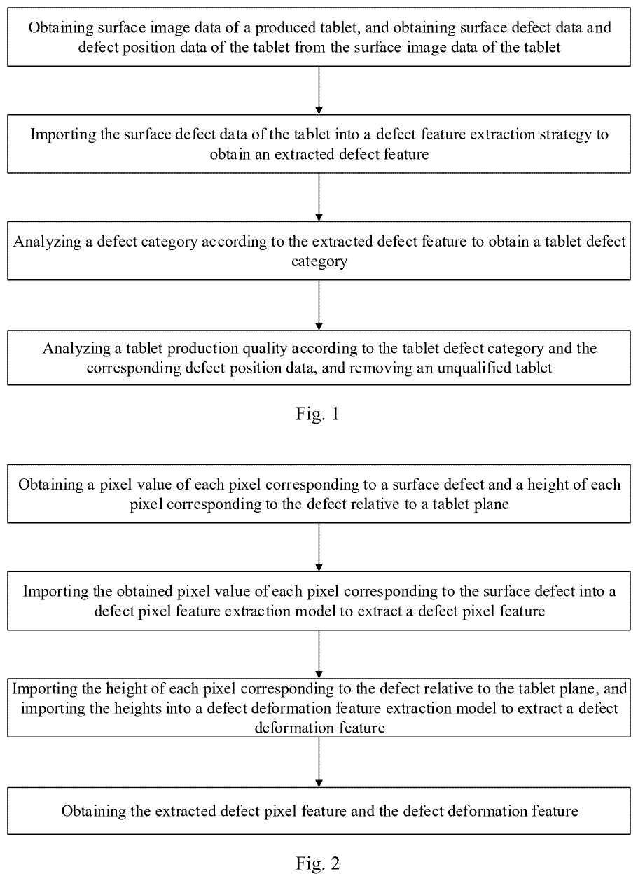

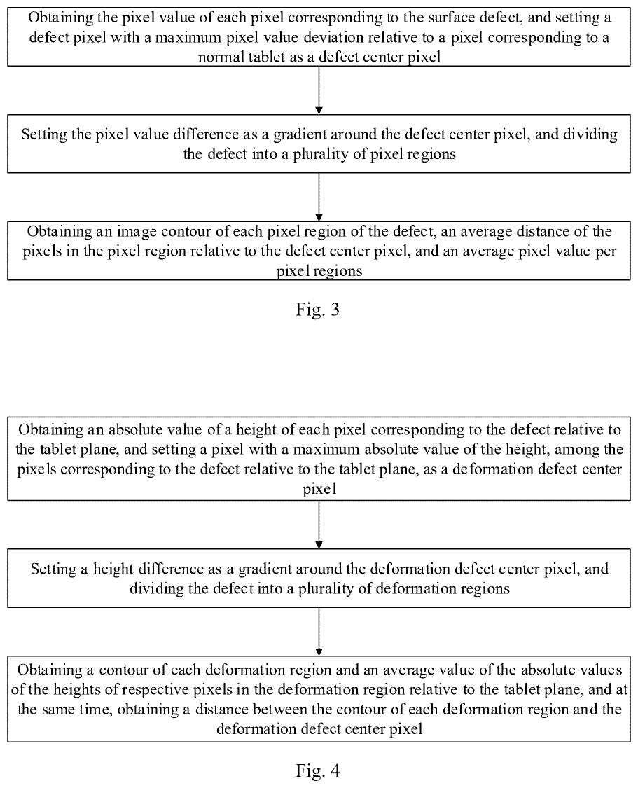

To solve the technical problems raised in the Background, the present disclosure provides an embodiment: as illustrated in FIGS. 1 to 4, a tablet quality inspection method based on modular machine vision recognition includes the following steps.
S1: obtaining surface image data of a produced tablet, and obtaining surface defect data and defect position data of the tablet from the surface image data of the tablet.

Specifically, for example, the image of the produced tablet may be collected using a visual machine (e.g., any device that can collect the image of the tablet, such as a camera), and the image may be sent to a server through the visual machine. After receiving the image, the server takes the image as the surface image data of the tablet to perform the following steps. In a particular embodiment, the obtaining the surface image data of the produced tablet, and obtaining the surface defect data and the defect position data of the tablet from the surface image data of the tablet specifically includes the following steps.
S11: spreading the produced tablet on a collecting end of a visual machine, and removing a background from collected images to obtain the surface image data of the produced tablet.

In a particular embodiment, the step of removing the background from collected images to obtain the surface image data of the produced tablet specifically includes: obtaining collected images which are collected using the visual machine, and at the same time, obtaining a pixel value of a normal tablet and an average pixel value of the background, obtaining the pixel values of the respective pixels on a surface of each collected image, setting the image including pixels with a pixel value difference relative to the normal tablet falling within a set safe pixel value range as a tablet surface image, setting the image including other pixels as a background image, and obtaining contours of all the tablet surface images and the pixel value of each pixel, where the set safe pixel value range is set according to a difference between the pixel value of the normal tablet and the average pixel value of the background, and for example is one fifth of the difference between the pixel value of the normal tablet and the average pixel value of the background of a normal tablet.
S12: comparing a contour of tablet surface image with that of the normal tablet to obtain a contour abnormal range, i.e., an image range in which the contour of the tablet surface image is different from that of the normal tablet, and comparing the pixel value of each pixel of the tablet surface image with that of the normal tablet to obtain a pixel abnormal range, i.e., an image range in which the pixel values of the tablet surface image are different from that of the normal tablet.
S13: setting the obtained contour abnormal range and pixel abnormal range of the tablets as the surface defect, and at the same time, obtaining closest distance data of the surface defect relative to a center position of the tablet, where the center position of the tablet is center data of a circumscribed circle of the tablet.
S2: importing the surface defect data of the tablet into a defect feature extraction strategy to obtain an extracted defect feature.

In a particular embodiment, the importing the surface defect data of the tablet into a defect feature extraction strategy to obtain the extracted defect feature specifically includes the following steps.
S21: obtaining a pixel value of each pixel corresponding to a surface defect and a height of each pixel corresponding to the defect relative to a tablet plane.
S22: importing the obtained pixel value of each pixel corresponding to the surface defect into a defect pixel feature extraction model to extract a defect pixel feature.

In a particular embodiment, the defect pixel feature extraction model specifically includes the following steps.
S221: obtaining the pixel value of each pixel corresponding to the surface defect, and setting a defect pixel with a maximum pixel value deviation relative to a pixel corresponding to a normal tablet as a defect center pixel;
S222: setting the pixel value difference as a gradient around the defect center pixel, and dividing the defect into a plurality of pixel regions. In order to distinguish the image with different pixel values of the defect, the pixel value difference is set according to the required accuracy, i.e., the set pixel value difference decreases as the required accuracy increases. For example, when it is necessary to divide the defect into 30 pixel regions, the pixel value difference is set to be at least 1/30 of a pixel value difference between the defect center pixel and the pixel corresponding to the normal tablet.
S223: obtaining an image contour of each pixel region of the defect, an average distance of the pixels in the pixel region relative to the defect center pixel, and an average pixel value per pixel regions.
S23: importing the height of each pixel corresponding to the defect relative to the tablet plane, and importing the heights into a defect deformation feature extraction model to extract a defect deformation feature.

In a particular embodiment, the defect deformation feature extraction model specifically includes the following steps.
S231: obtaining an absolute value of a height of each pixel corresponding to the defect relative to the tablet plane, and setting a pixel with a maximum absolute value of the height, among the pixels corresponding to the defect relative to the tablet plane, as a deformation defect center pixel;
S232: setting a height difference as a gradient around the deformation defect center pixel, and dividing the defect into a plurality of deformation regions;
S233: obtaining a contour of each deformation region and an average value of the absolute values of the heights of respective pixels in the deformation region relative to the tablet plane, and at the same time, obtaining a distance between the contour of each deformation region and the deformation defect center pixel.
S24: obtaining the extracted defect pixel feature and the defect deformation feature.
S3: analyzing a defect category according to the extracted defect feature to obtain a tablet defect category.

In a particular embodiment, the analyzing the defect category according to the extracted defect feature to obtain the tablet defect category specifically includes the following steps.
S31: obtaining an image contour of each pixel region of the defect, an average distance of the pixels in the pixel region from the defect center pixel and an average pixel value per pixel regions, and at the same time, obtaining the image contour of each pixel region of a historically classified defect, all of which are imported into a defect pixel category judgment value calculation formula to calculate a defect pixel category judgment value, and the defect pixel category judgment value calculation formula is

$$Px = {\sum }_{i = 1}^{m} \frac{xi \times Lz \times S ( si ⋂ siw )}{( xi + \vert xi - xis \vert ) \times Li \times S ( si ⋃ siw )} ,$$

where m is the number of defect pixel regions, xi is an average pixel value corresponding to an i-th pixel region of the defect, Lz is a diameter of the tablet, Li is an average distance of the pixels in the i-th pixel region relative to the defect center pixel, S () denotes an area of the image in the bracket, si is a contour image corresponding to the i-th pixel region of the defect, siw is an image contour of the historically classified defect corresponding to the i-th pixel region, xis is an average pixel value of the historically classified defect corresponding to the i-th pixel region, [symbol] is an intersection of contours, and [symbol] is a union of contours. To be noted here, in the above formula,

$$\frac{S ( si ⋂ siw )}{S ( si ⋃ siw )}$$

is a similarity of contours,

$$\frac{x i}{\vert xi - xis \vert}$$

is a similarity of pixel values. To prevent division by zero, xi is added to the denominator. However, due to the varying weights assigned based on proximity to the center of the defect, and the importance certainly increases as the distance to the center of the defect decreases, a reciprocal of the average distance of the pixels in the i-th pixel region relative to the defect center pixel is used here as the weight, and the similarity between two defect contours at the pixel level can be accurately analyzed through the above formula.
S32: obtaining a contour of each deformation region of the defect, an average value of the absolute values of the heights of the respective pixels in the deformation region relative to the tablet plane, and an average distance between the contour of each deformation region and the deformation defect center pixel, and at the same time, obtaining the contour of each deformation region of the historically classified defect and an average value of the absolute values of the heights of the respective pixels in the deformation region of the historically classified defect relative to the tablet plane, all of which are imported into a defect deformation category judgment value calculation formula to calculate a defect deformation category judgment value, and the defect deformation category judgment value calculation formula is

$$Pb = {\sum }_{j = 1}^{n} \frac{c j \times Lz \times S ( zj ⋂ zjw )}{( cj + \vert cj - cjs \vert ) \times Dj \times S ( zj ⋃ zjw )} ,$$

where n is the number of deformation regions of the defect, cj is an average value of the absolute values of the heights of the respective pixels in an j-th deformation region relative to the tablet plane, cjs is an average value of the absolute values of the heights of the respective pixels in the historically classified defect corresponding to the j-th deformation region relative to the tablet plane, Dj is an average distance between a contour of the j-th deformation region and the deformation defect center pixel, zj is the contour of the j-th deformation region of the defect, and zjw is the contour of the historically classified defect corresponding to the j-th deformation region.
S33: obtaining defect pixel category judgment values and defect deformation category judgment values of the defect and the historically classified defect, all of which are imported into a defect similarity value calculation formula to calculate a defect similarity value, and the defect similarity value calculation formula is Mk=aPx+(1−a)Pb, where a is a pixel similarity ratio.
S34: obtaining the defect similarity values of all the historically classified defects relative to the defect to be recognized, and setting the category of the historically classified defect corresponding to the maximum defect similarity value as the category of the defect to be recognized.

In addition, it should be noted that the image contours of the respective pixel regions of the historically classified defect are the image contours of the respective pixel regions in the image where the defect category has been accurately determined at present. For example, this embodiment includes a plurality of defect categories, and there is at least one image corresponding to each defect category, so that the image contours of the respective pixel regions in the image are those of the respective pixel regions in the image of the defect category. Similarly, the contours of the respective deformation regions of the historically classified defect and the average value of the absolute values of the heights of the respective pixels in each deformation region of the historically classified defect are: the contours of the respective deformation regions in the image where the defect category has been accurately determined at present, and the average value of the absolute values of the heights of the respective pixels in each deformation region in the image where the defect category has been accurately determined relative to the tablet plane, respectively. For example, this embodiment includes a plurality of defect categories, and there is at least one image corresponding to each defect category, so that the contours of the respective deformation regions in the image and the average value of the absolute values of the heights of the respective pixels of each deformation region relative to the tablet plane are the contours of the respective deformation regions in the image of the defect category and the average value of the absolute values of the heights of the respective pixels of each deformation region in the image of the defect category relative to the tablet plane, respectively. On this basis, it is clear that there are a plurality of defect pixel judgment values in the current method, and each defect pixel judgment value is corresponding to a defect category; there are a plurality of defect deformation category judgment values in the current method, and each defect deformation category judgment value is corresponding to a defect category; and there are a plurality of defect similarity values in the current method, and each defect similarity value is corresponding to a defect category.
S4: analyzing a tablet production quality according to the tablet defect category and the corresponding defect position data, and removing an unqualified tablet.

In a particular embodiment, the analyzing the tablet production quality according to the tablet defect category and the corresponding defect position data specifically includes the following steps.
S41: obtaining a quality base value corresponding to the recognized defect; it should be noted that the quality base value is set in the reason that different defects (e.g., cracks and surface bulges) have different degrees of damages to the tablet, so it is necessary to set different quality base values for different defects; and at the same time, obtaining the pixel values of the respective pixels of the defect and the absolute values of the heights of the respective pixels of the defect relative to the tablet plane, and importing the obtained pixel values of the respective pixels of the defect and the absolute values of the heights of the respective pixels of the defect relative to the tablet plane into a defect abnormal value calculation formula to calculate a defect abnormal value, and the defect abnormal value calculation formula is

$$Q x = {\sum }_{c = 1}^{Y} \frac{\vert pc - pcm \vert}{p c m} exp ( \frac{J c}{J m} ) ,$$

where Y is the number of pixels of the defect, pc is a pixel value of a c-th pixel of the defect, pcm is a pixel value of the tablet, exp () represents a natural constant e raised to a specified power, Jc is an absolute value of a height of the c-th pixel of the defect relative to the tablet plane, and Jm is a thickness of the tablet.
S42: obtaining the defect abnormal value, the quality base value and the closest distance data relative to a center position of the tablet of each defect on the tablet, all of which are imported into a tablet quality calculation formula to calculate a tablet quality, and the tablet quality calculation formula is

$$F = 1 - \frac{{\sum }_{r = 1}^{R} Q x r \times Tr \times ln ( 1 + \frac{Hm}{Hr + Hm} )}{Qm} ,$$

where R is the number of defects on the tablet, Qxr is a defect abnormal value of an r-th defect, Tr is a quality base value of the r-th defect, ln () represents a logarithm with base the natural constant e, Hm is an average diameter of the tablet, Hr is closest distance data of the r-th defect relative to the center position of the tablet, and Qm is a set defect abnormality threshold. It should be noted here that considering that defects closer to the center of the tablet impose higher criticality, greater weight is assigned as the defect is closer to the center position of the tablet. To adjust the value range of the tablet quality, the defect abnormality threshold may be set arbitrarily by an experimenter as needed.
S43: comparing the obtained tablet quality with a set tablet quality threshold, when the tablet quality is greater than or equal to the set tablet quality threshold, determining the tablet quality to be qualified, and when the tablet quality is less than the set tablet quality threshold, determining the tablet quality to be unqualified.

It should be noted here that the values of parameters such as the tablet quality threshold, the quality base value and the pixel similarity ratio in this embodiment are set as follows: obtaining 1000 groups of surface image data of the produced tablets, obtaining surface defect data and defect position data of the tablets from the surface image data of the tablets, importing the surface defect data and defect position data of the tablets into a tablet quality calculation formula to calculate tablet qualities, obtaining judgment results of whether these tablets are qualified from hired experts, importing the tablet qualities and the judgment results of whether the tablets are qualified into fitting software, and outputting the values of a tablet quality threshold, a quality base value, a pixel similarity ratio, etc. which meet a maximum judgment accuracy.

In addition, S43 may further include, for example, when the tablet quality is determined to be qualified, the server displays a representation corresponding to the qualified tablet quality on a user terminal (or a visual machine) through interaction with the user terminal (or interaction with the visual machine) for the user's review. When the tablet quality is determined to be unqualified, the server displays a representation corresponding to the unqualified tablet quality on the user terminal (or the visual machine) through interaction with the user terminal (or interaction with the visual machine) for the user's review. For example, in a case where the tablet quality is determined to be unqualified, the server may further control a removal device (e.g., a mechanical arm) to remove the tablet, thereby removing the unqualified tablet.

The advantages compared with the prior art are specifically as follows: this embodiment obtains the surface image data of the produced tablet, obtains the surface defect data and the defect position data of the tablet from the surface image data of the tablet, imports the surface defect data of the tablet into the defect feature extraction strategy to obtain an extracted defect feature, analyzes the defect category according to the extracted defect feature, and obtains the tablet defect category, and analyzes a tablet production quality according to the tablet defect category and the corresponding defect position data, thereby accurately analyzing the tablet image, extract implicit features reflecting tablet defects, accurately analyze the defect category according to the implicit features of the defects, and then accurately analyze tablet quality according to the classified defect categories and positions, thereby improving the accuracy and the efficiency of a tablet quality inspection.

### Embodiment 2

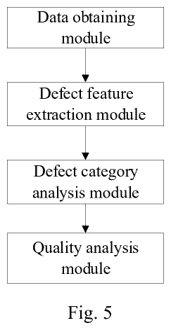

FIG. 5 illustrates a tablet quality inspection system based on modular machine vision recognition, which is implemented on the basis of the aforementioned tablet quality inspection method based on modular machine vision recognition, and specifically includes a data obtaining module, a defect feature extraction module, a defect category analysis module and a quality analysis module; the data obtaining module is configured to obtain surface image data of a produced tablet, and obtain surface defect data and defect position data of the tablet from the surface image data of the tablet; the defect feature extraction module is configured to import the surface defect data of the tablet into a defect feature extraction strategy to obtain an extracted defect feature; the defect category analysis module is configured to analyze a defect category according to the extracted defect feature to obtain a tablet defect category; the quality analysis module is configured to analyze a tablet production quality according to the tablet defect category and the corresponding defect position data, and remove an unqualified tablet; and a control module may be further included to control the operations of the data obtaining module, the defect feature extraction module, the defect category analysis module and the quality analysis module.

### Embodiment 3

This embodiment provides an electronic device, including a processor and a memory, and the memory stores a computer program that can be called by the processor;
the processor implements the aforementioned tablet quality inspection method based on modular machine vision recognition by calling the computer program stored in the memory.

The electronic device may be quite different due to variations in configuration or performance, and may include one or more processors and one or more memories, and the memory stores at least one computer program, which is loaded and executed by the processor to implement a tablet quality inspection method based on modular machine vision recognition according to the method embodiment. The electronic device may further include other components that realize the functions of the device. For example, the electronic device may further include components such as a wired or wireless network interface, an input and output interface, etc. for data input and output, which will not be described in detail in this embodiment.

### Embodiment 4

This embodiment proposes a computer-readable storage medium, which stores an erasable computer program;
when run on a computer device, the computer program enables the computer device to implement the aforementioned tablet quality inspection method based on modular machine vision recognition.

For example, the computer-readable storage medium may be a read-only memory, a random-access memory, a read-only optical disk, a magnetic tape, a floppy disk, an optical data storage device, or the like.

The above embodiments may be implemented in whole or in part by software, hardware, firmware or any other combination. When implemented by software, the above embodiments may be implemented in whole or in part in the form of a computer program product. The computer program product includes one or more computer instructions or computer programs. When loaded or executed on a computer, the computer instructions or the computer programs produce the processes or functions according to the embodiments of the present disclosure in whole or in part. The computer may be a general computer, a dedicated computer, a computer network or any other programmable device. The computer instructions may be stored in a computer-readable storage medium or transmitted from one computer-readable storage medium to another computer-readable storage medium. For example, the computer instructions may be transmitted from one website site, computer, server or data center to another website site, computer, server or data center through a wired network and/or a wireless network. The computer-readable storage medium may be any available medium accessible by a computer, or a data storage device that contains one or more sets of available media, such as a server, a data center, or the like. The available medium may be a magnetic medium (e.g., a floppy disk, a hard disk or a magnetic tape), an optical medium (e.g., a DVD), or a semiconductor medium. The semiconductor medium may be a solid-state hard disk.

The term “comprise”, “include” or any other variation thereof is intended to cover non-exclusive inclusions, so that a process, method, article or device that includes a series of elements includes not only those elements, but also other elements not explicitly listed, or further includes elements inherent to such process, method, article or device.

Those described above are only preferred embodiments of the present disclosure and the explanations of the applied technical principles. It should be understood by those skilled in the art that the application range involved in the present disclosure is not limited to the technical solutions obtained from the specific combinations of the above technical features, but also covers other technical solutions obtained from any combination of the above technical features or equivalent features thereof without departing from the aforementioned application concepts, such as the technical solutions obtained by mutually replacement between the above features and the technical features with similar functions applied for in the present disclosure (but not limited thereto).

What is claimed is:

1. A tablet quality inspection method based on modular machine vision recognition, comprising:
obtaining surface image data of a produced tablet, and obtaining surface defect data and defect position data of the tablet from the surface image data of the tablet;
importing the surface defect data of the tablet into a defect feature extraction strategy to obtain an extracted defect feature,
wherein the importing the surface defect data of the tablet into a defect feature extraction strategy to obtain the extracted defect feature comprises:
obtaining a pixel value of each pixel corresponding to a surface defect and a height of each pixel corresponding to the defect relative to a tablet plane,
importing the obtained pixel value of each pixel corresponding to the surface defect into a defect pixel feature extraction model to extract a defect pixel feature,
importing the height of each pixel corresponding to the defect relative to the tablet plane into a defect deformation feature extraction model to extract a defect deformation feature, and
obtaining the extracted defect pixel feature and the defect deformation feature;
wherein the defect pixel feature extraction model comprises:
obtaining the pixel value of each pixel corresponding to the surface defect, and setting a defect pixel with a maximum pixel value deviation relative to a pixel corresponding to a normal tablet as a defect center pixel,
setting the pixel value difference as a gradient around the defect center pixel, and dividing the defect into a plurality of pixel regions, and
obtaining an image contour of each pixel region of the defect, an average distance of the pixels in the pixel region relative to the defect center pixel, and an average pixel value per pixel region; and
wherein the defect deformation feature extraction model comprises:
obtaining an absolute value of a height of each pixel corresponding to the defect relative to the tablet plane, and setting a pixel with a maximum absolute value of the height, among the pixels corresponding to the defect relative to the tablet plane, as a deformation defect center pixel,
setting a height difference as a gradient around the deformation defect center pixel, and dividing the defect into a plurality of deformation regions, and
obtaining a contour of each deformation region and an average value of the absolute values of the heights of respective pixels in the deformation region relative to the tablet plane,
and at the same time, obtaining a distance between the contour of each deformation region and the deformation defect center pixel;
analyzing a defect category according to the extracted defect feature to obtain a tablet defect category; and
analyzing a tablet production quality according to the tablet defect category and the corresponding defect position data, and removing an unqualified tablet.

2. The tablet quality inspection method based on modular machine vision recognition according to claim 1, wherein the obtaining the surface image data of the produced tablet, and obtaining the surface defect data and the defect position data of the tablet from the surface image data of the tablet comprises:
spreading the produced tablet on a collecting end of a visual machine, and removing a background from collected images to obtain the surface image data of the produced tablet;
comparing a contour of the tablet surface image with that of the normal tablet to obtain a contour abnormal range, and comparing the pixel value of each pixel of the tablet surface image with that of the normal tablet to obtain a pixel abnormal range; and
setting the obtained contour abnormal range and pixel abnormal range of the tablet as the surface defect, and at the same time, obtaining closest distance data of the surface defect relative to a center position of the tablet.

3. The tablet quality inspection method based on modular machine vision recognition according to claim 2, wherein the analyzing the defect category according to the extracted defect feature to obtain the tablet defect category comprises: obtaining an image contour of each pixel region of the defect, an average distance of the pixels in the pixel region from the defect center pixel and an average pixel value per pixel region, and at the same time, obtaining the image contour of each pixel region of a historically classified defect, all of which are imported into a defect pixel category judgment value calculation formula to calculate a defect pixel category judgment value, wherein the defect pixel category judgment value calculation formula is
$$Px = {\sum }_{i = 1}^{m} \frac{xi \times Lz \times S ( si ⋂ siw )}{( xi + \vert xi - xis \vert ) \times Li \times S ( si ⋃ siw )} ,$$
where m is the number of defect pixel regions, xi is an average pixel value corresponding to an i-th pixel region of the defect, Lz is a diameter of the tablet, Li is an average distance of the pixels in the i-th pixel region relative to the defect center pixel, S () denotes an area of the image in the bracket, si is a contour image corresponding to the i-th pixel region of the defect, siw is an image contour of the historically classified defect corresponding to the i-th pixel region, xis is an average pixel value of the historically classified defect corresponding to the i-th pixel region, [symbol] is an intersection of contours, and [symbol] is a union of contours.

4. The tablet quality inspection method based on modular machine vision recognition according to claim 3, wherein the analyzing the defect category according to the extracted defect feature to obtain the tablet defect category further comprises:
obtaining a contour of each deformation region of the defect, an average value of the absolute values of the heights of the respective pixels in the deformation region relative to the tablet plane, and an average distance between the contour of each deformation region and the deformation defect center pixel, and at the same time, obtaining the contour of each deformation region of the historically classified defect and an average value of the absolute values of the heights of the respective pixels in the deformation region of the historically classified defect relative to the tablet plane, all of which are imported into a defect deformation category judgment value calculation formula to calculate a defect deformation category judgment value, wherein the defect deformation category judgment value calculation formula is
$$Pb = {\sum }_{j = 1}^{n} \frac{c j \times Lz \times S ( zj ⋂ zjw )}{( cj + \vert cj - cjs \vert ) \times Dj \times S ( zj ⋃ zjw )} ,$$
where n is the number of deformation regions of the defect, cj is an average value of the absolute values of the heights of the respective pixels in an j-th deformation region relative to the tablet plane, cjs is an average value of the absolute values of the heights of the respective pixels in the historically classified defect corresponding to the j-th deformation region relative to the tablet plane, Dj is an average distance between a contour of the j-th deformation region and the deformation defect center pixel, zj is the contour of the j-th deformation region of the defect, and zjw is the contour of the historically classified defect corresponding to the j-th deformation region.

5. The tablet quality inspection method based on modular machine vision recognition according to claim 4, wherein the analyzing the defect category according to the extracted defect feature to obtain the tablet defect category further comprises: obtaining the defect pixel category judgment values and the defect deformation category judgment values of the defect and the historically classified defect, all of which are imported into a defect similarity value calculation formula to calculate a defect similarity value, wherein the defect similarity value calculation formula is Mk=aPx+(1−a)Pb, where a is a pixel similarity ratio; and obtaining the defect similarity values of all the historically classified defects relative to the defect to be recognized, and setting the category of the historically classified defect corresponding to the maximum defect similarity value as the category of the defect to be recognized.

6. The tablet quality inspection method based on modular machine vision recognition according to claim 5, wherein the analyzing the tablet production quality according to the tablet defect category and the corresponding defect position data comprises: obtaining a quality base value corresponding to the recognized defect, and at the same time, obtaining the pixel values of the respective pixels of the defect and the absolute values of the heights of the respective pixels of the defect relative to the tablet plane, and importing the obtained pixel values of the respective pixels of the defect and the absolute values of the heights of the respective pixels of the defect relative to the tablet plane into a defect abnormal value calculation formula to calculate a defect abnormal value, wherein the defect abnormal value calculation formula is
$$Qx = {\sum }_{c = 1}^{Y} \frac{\vert pc - pcm \vert}{p c m} exp ( \frac{J c}{J m} ) ,$$
where Y is the number of pixels of the defect, pc is a pixel value of a c-th pixel of the defect, pcm is a pixel value of the tablet, exp () represents a natural constant e raised to a specified power, Jc is an absolute value of a height of the c-th pixel of the defect relative to the tablet plane, and Jm is a thickness of the tablet.

7. The tablet quality inspection method based on modular machine vision recognition according to claim 6, wherein the analyzing the tablet production quality according to the tablet defect category and the corresponding defect position data further comprises: obtaining the defect abnormal value, the quality base value and the closest distance data relative to a center position of the tablet of each defect on the tablet, all of which are imported into a tablet quality calculation formula to calculate a tablet quality, wherein the tablet quality calculation formula is
$$F = 1 - \frac{{\sum }_{r = 1}^{R} Q x r \times Tr \times ln ( 1 + \frac{Hm}{Hr + Hm} )}{Qm} ,$$
where R is the number of defects on the tablet, Qxr is a defect abnormal value of an r-th defect, Tr is a quality base value of the r-th defect, ln () represents a logarithm with base the natural constant e, Hm is an average diameter of the tablet, Hr is closest distance data of the r-th defect relative to the center position of the tablet, and Qm is a set defect abnormality threshold; and comparing the obtained tablet quality with a set tablet quality threshold, when the tablet quality is greater than or equal to the set tablet quality threshold, determining the tablet quality to be qualified, and when the tablet quality is less than the set tablet quality threshold, determining the tablet quality to be unqualified.

8. The tablet quality inspection method based on modular machine vision recognition according to claim 7, wherein the removing the background from collected images to obtain the surface image data of the produced tablet comprises: obtaining collected images from the visual machine, and at the same time, obtaining a pixel value of a normal tablet and an average pixel value of the background, obtaining the pixel values of the respective pixels on a surface of each collected image, setting an image with a pixel value difference relative to the normal tablet falling within a set safe pixel value range as a tablet surface image, setting other images as background images, and obtaining contours of all the tablet surface images and the pixel value of each pixel.

9. A tablet quality inspection system based on modular machine vision recognition, which is implemented on the basis of a tablet quality inspection method based on modular machine vision recognition, comprising a data obtaining module, a defect feature extraction module, a defect category analysis module and a quality analysis module;
wherein the data obtaining module is configured to obtain surface image data of a produced tablet, and obtain surface defect data and defect position data of the tablet from the surface image data of the tablet;
the defect feature extraction module is configured to import the surface defect data of the tablet into a defect feature extraction strategy to obtain an extracted defect feature;
the defect category analysis module is configured to analyze a defect category according to the extracted defect feature to obtain a tablet defect category; and
the quality analysis module is configured to analyze a tablet production quality according to the tablet defect category and the corresponding defect position data, and remove an unqualified tablet,
wherein the tablet quality inspection method based on modular machine vision recognition comprises:
obtaining surface image data of a produced tablet, and obtaining surface defect data and defect position data of the tablet from the surface image data of the tablet;
importing the surface defect data of the tablet into a defect feature extraction strategy to obtain an extracted defect feature,
wherein the importing the surface defect data of the tablet into a defect feature extraction strategy to obtain the extracted defect feature comprises:
obtaining a pixel value of each pixel corresponding to a surface defect and a height of each pixel corresponding to the defect relative to a tablet plane,
importing the obtained pixel value of each pixel corresponding to the surface defect into a defect pixel feature extraction model to extract a defect pixel feature,
importing the height of each pixel corresponding to the defect relative to the tablet plane into a defect deformation feature extraction model to extract a defect deformation feature, and
obtaining the extracted defect pixel feature and the defect deformation feature;
wherein the defect pixel feature extraction model comprises:
obtaining the pixel value of each pixel corresponding to the surface defect, and setting a defect pixel with a maximum pixel value deviation relative to a pixel corresponding to a normal tablet as a defect center pixel,
setting the pixel value difference as a gradient around the defect center pixel, and dividing the defect into a plurality of pixel regions, and
obtaining an image contour of each pixel region of the defect, an average distance of the pixels in the pixel region relative to the defect center pixel, and an average pixel value per pixel region; and
wherein the defect deformation feature extraction model comprises:
obtaining an absolute value of a height of each pixel corresponding to the defect relative to the tablet plane, and setting a pixel with a maximum absolute value of the height, among the pixels corresponding to the defect relative to the tablet plane, as a deformation defect center pixel,
setting a height difference as a gradient around the deformation defect center pixel, and dividing the defect into a plurality of deformation regions, and
obtaining a contour of each deformation region and an average value of the absolute values of the heights of respective pixels in the deformation region relative to the tablet plane, and at the same time, obtaining a distance between the contour of each deformation region and the deformation defect center pixel;
analyzing a defect category according to the extracted defect feature to obtain a tablet defect category; and
analyzing a tablet production quality according to the tablet defect category and the corresponding defect position data, and removing an unqualified tablet.

10. The tablet quality inspection system based on modular machine vision recognition according to claim 9, further comprising a control module configured to control the operations of the data obtaining module, the defect feature extraction module, the defect category analysis module and the quality analysis module.

11. An electronic device, comprising: a processor and a memory, wherein the memory stores a computer program that can be called by the processor;
wherein the processor implements a tablet quality inspection method based on modular machine vision recognition by calling the computer program stored in the memory,
wherein the tablet quality inspection method based on modular machine vision recognition comprises:
obtaining surface image data of a produced tablet, and obtaining surface defect data and defect position data of the tablet from the surface image data of the tablet;
importing the surface defect data of the tablet into a defect feature extraction strategy to obtain an extracted defect feature;
wherein the importing the surface defect data of the tablet into a defect feature extraction strategy to obtain the extracted defect feature comprises:
obtaining a pixel value of each pixel corresponding to a surface defect and a height of each pixel corresponding to the defect relative to a tablet plane,
importing the obtained pixel value of each pixel corresponding to the surface defect into a defect pixel feature extraction model to extract a defect pixel feature,
importing the, height of each pixel corresponding to the defect relative to the tablet plane into a defect deformation feature extraction model to extract a defect deformation feature, and
obtaining the extracted defect pixel feature and the defect deformation feature;
wherein the defect pixel feature extraction model comprises:
obtaining the pixel value of each pixel corresponding to the surface defect, and setting a defect pixel with a maximum pixel value deviation relative to a pixel corresponding to a normal tablet as a defect center pixel,
setting the pixel value difference as a gradient around the defect center pixel, and dividing the defect into a plurality of pixel regions, and
obtaining an image contour of each pixel region of the defect, an average distance of the pixels in the pixel region relative to the defect center pixel, and an average pixel value per pixel region; and
wherein the defect deformation feature extraction model comprises:
obtaining an absolute value of a height of each pixel corresponding to the defect relative to the tablet plane, and setting a pixel with a maximum absolute value of the height, among the pixels corresponding to the defect relative to the tablet plane, as a deformation defect center pixel,
setting a height difference as a gradient around the deformation defect center pixel, and dividing the defect into a plurality of deformation regions, and
obtaining a contour of each deformation region and an average value of the absolute values of the heights of respective pixels in the deformation region relative to the tablet plane, and at the same time, obtaining a distance between the contour of each deformation region and the deformation defect center pixel;
analyzing a defect category according to the extracted defect feature to obtain a tablet defect category; and
analyzing a tablet production quality according to the tablet defect category and the corresponding defect position data, and removing an unqualified tablet.

12. The tablet quality inspection system based on modular machine vision recognition according to claim 9, wherein the obtaining the surface image data of the produced tablet, and obtaining the surface defect data and the defect position data of the tablet from the surface image data of the tablet comprises:
spreading the produced tablet on a collecting end of a visual machine, and removing a background from collected images to obtain the surface image data of the produced tablet;
comparing a contour of the tablet surface image with that of the normal tablet to obtain a contour abnormal range, and comparing the pixel value of each pixel of the tablet surface image with that of the normal tablet to obtain a pixel abnormal range; and
setting the obtained contour abnormal range and pixel abnormal range of the tablet as the surface defect, and at the same time, obtaining closest distance data of the surface defect relative to a center position of the tablet.

13. The tablet quality inspection system based on modular machine vision recognition according to claim 12, wherein the analyzing the defect category according to the extracted defect feature to obtain the tablet defect category comprises: obtaining an image contour of each pixel region of the defect, an average distance of the pixels in the pixel region from the defect center pixel and an average pixel value per pixel region, and at the same time, obtaining the image contour of each pixel region of a historically classified defect, all of which are imported into a defect pixel category judgment value calculation formula to calculate a defect pixel category judgment value, wherein the defect pixel category judgment value calculation formula is
$$Px = {\sum }_{i = 1}^{m} \frac{xi \times Lz \times S ( si ⋂ siw )}{( xi + \vert xi - xis \vert ) \times Li \times S ( si ⋃ siw )} ,$$
where m is the number of defect pixel regions, xi is an average pixel value corresponding to an i-th pixel region of the defect, Lz is a diameter of the tablet, Li is an average distance of the pixels in the i-th pixel region relative to the defect center pixel, S () denotes an area of the image in the bracket, si is a contour image corresponding to the i-th pixel region of the defect, siw is an image contour of the historically classified defect corresponding to the i-th pixel region, xis is an average pixel value of the historically classified defect corresponding to the i-th pixel region, [symbol] is an intersection of contours, and [symbol] is a union of contours.

14. The tablet quality inspection system based on modular machine vision recognition according to claim 13, wherein the analyzing the defect category according to the extracted defect feature to obtain the tablet defect category further comprises:
obtaining a contour of each deformation region of the defect, an average value of the absolute values of the heights of the respective pixels in the deformation region relative to the tablet plane, and an average distance between the contour of each deformation region and the deformation defect center pixel, and at the same time, obtaining the contour of each deformation region of the historically classified defect and an average value of the absolute values of the heights of the respective pixels in the deformation region of the historically classified defect relative to the tablet plane, all of which are imported into a defect deformation category judgment value calculation formula to calculate a defect deformation category judgment value, wherein the defect deformation category judgment value calculation formula is
$$Pb = {\sum }_{j = 1}^{n} \frac{c j \times Lz \times S ( zj ⋂ zjw )}{( cj + \vert cj - cjs \vert ) \times Dj \times S ( zj ⋃ zjw )} ,$$
where n is the number of deformation regions of the defect, cj is an average value of the absolute values of the heights of the respective pixels in an j-th deformation region relative to the tablet plane, cjs is an average value of the absolute values of the heights of the respective pixels in the historically classified defect corresponding to the j-th deformation region relative to the tablet plane, Dj is an average distance between a contour of the j-th deformation region and the deformation defect center pixel, zj is the contour of the j-th deformation region of the defect, and zjw is the contour of the historically classified defect corresponding to the j-th deformation region.

15. The tablet quality inspection system based on modular machine vision recognition according to claim 14, wherein the analyzing the defect category according to the extracted defect feature to obtain the tablet defect category further comprises: obtaining the defect pixel category judgment values and the defect deformation category judgment values of the defect and the historically classified defect, all of which are imported into a defect similarity value calculation formula to calculate a defect similarity value, wherein the defect similarity value calculation formula is Mk=aPx+(1−a)Pb, where a is a pixel similarity ratio; and obtaining the defect similarity values of all the historically classified defects relative to the defect to be recognized, and setting the category of the historically classified defect corresponding to the maximum defect similarity value as the category of the defect to be recognized.

16. The tablet quality inspection system based on modular machine vision recognition according to claim 15, wherein the analyzing the tablet production quality according to the tablet defect category and the corresponding defect position data comprises: obtaining a quality base value corresponding to the recognized defect, and at the same time, obtaining the pixel values of the respective pixels of the defect and the absolute values of the heights of the respective pixels of the defect relative to the tablet plane, and importing the obtained pixel values of the respective pixels of the defect and the absolute values of the heights of the respective pixels of the defect relative to the tablet plane into a defect abnormal value calculation formula to calculate a defect abnormal value, wherein the defect abnormal value calculation formula is
$$Qx = {\sum }_{c = 1}^{Y} \frac{\vert pc - pcm \vert}{p c m} exp ( \frac{J c}{J m} ) ,$$
where Y is the number of pixels of the defect, pc is a pixel value of a c-th pixel of the defect, pem is a pixel value of the tablet, exp () represents a natural constant e raised to a specified power, Jc is an absolute value of a height of the c-th pixel of the defect relative to the tablet plane, and Jm is a thickness of the tablet.

17. The tablet quality inspection system based on modular machine vision recognition according to claim 16, wherein the analyzing the tablet production quality according to the tablet defect category and the corresponding defect position data further comprises: obtaining the defect abnormal value, the quality base value and the closest distance data relative to a center position of the tablet of each defect on the tablet, all of which are imported into a tablet quality calculation formula to calculate a tablet quality, wherein the tablet quality calculation formula is
$$F = 1 - \frac{{\sum }_{r = 1}^{R} Q x r \times Tr \times ln ( 1 + \frac{Hm}{Hr + Hm} )}{Qm} ,$$
where R is the number of defects on the tablet, Qxr is a defect abnormal value of an r-th defect, Tr is a quality base value of the r-th defect, ln () represents a logarithm with base the natural constant e, Hm is an average diameter of the tablet, Hr is closest distance data of the r-th defect relative to the center position of the tablet, and Qm is a set defect abnormality threshold; and comparing the obtained tablet quality with a set tablet quality threshold, when the tablet quality is greater than or equal to the set tablet quality threshold, determining the tablet quality to be qualified, and when the tablet quality is less than the set tablet quality threshold, determining the tablet quality to be unqualified.

18. The tablet quality inspection system based on modular machine vision recognition according to claim 17, wherein the removing the background from collected images to obtain the surface image data of the produced tablet comprises: obtaining collected images from the visual machine, and at the same time, obtaining a pixel value of a normal tablet and an average pixel value of the background, obtaining the pixel values of the respective pixels on a surface of each collected image, setting an image with a pixel value difference relative to the normal tablet falling within a set safe pixel value range as a tablet surface image, setting other images as background images, and obtaining contours of all the tablet surface images and the pixel value of each pixel.
